(19) United States
(12) Patent Application Publication
(10) Pub. No.: US 2003/0043594 A1
(43) Pub. Date: Mar. 6, 2003

(54) Traffic light

(76) Inventors: Chen-Lun Hsing Chen, Taipei Hsien (TW); Po-Hsien Lee, Taipei Hsien (TW); I-Hsiang Li, Taipei Hsien (TW)

Correspondence Address: RABIN & BERDO, P.C., Suite 500, 1101 14 Street, N.W., Washington, DC, 20005, US

(21) Appl. No.: 09/939,568

(22) Filed: Aug. 28, 2001

(51) Int. Cl. F21V 7/04

(52) U.S. Cl. 362/555

(57) ABSTRACT

A traffic light comprises a lampshade having a base, a copper plate placed on an inner side of the base and a plurality of LEDs. The copper plate is aligned with 5-45° angle with respect to the base of the lampshade. The LEDs are arranged on the copper plate. The traffic light uses less number of LEDs and has enhanced security.

### FIELD OF THE INVENTION

The present invention relates to a traffic light, especially to a traffic light using light emitting diode with low thermal resistance as light source.

### BACKGROUND OF THE INVENTION

The traffic light is generally used in cross road or railroad crossing for indication or warming application. The prior art traffic light can be classified into following categories:

(A). As shown in FIG. 1, the traffic light uses light bulb 60 as light source. The light bulb 60 is arranged on a mounting plate 11 of a lampshade 1. Moreover, the lampshade 1 contains a light diffusion plate 5 therein and used to diffuse the light from the light bulb 60. The diffusive light is emitted from a lamp cover 4 at front side of the lampshade 1.

However, the traffic light shown in FIG. 1 has following drawbacks:

(1). Poor safety

The light bulb has relatively short life and the performance of the traffic light is influenced if light bulb therein is damaged.

(2). High maintenance cost

The average life of light bulb is about 5000 hours, the maintenance cost thereof is high.

(3). High power consumption

The light bulb generally consumes power of 60-100W, which is relatively large in comparison with the power consumption of 20W for LED lamp.

(B). As shown in FIG. 2, the traffic light uses a plurality of LEDs 70 of φ3 mm or φ5 mm as light source and the LEDs 70 are arranged behind a lamp cover 4 at front side of the lampshade 1.

However, the traffic light shown in FIG. 2 using LEDs as light source has following drawbacks:

(1). Non-uniform Light Emission

The LEDs are placed at proximity of the lamp cover and the emitted light might have the problem of non-uniform illumination if one of the LEDs is damaged.

(2). Poor Efficiency of Light Source Utilization

The traffic rule has no regulation about the illumination atop the central axial line of the lamp cover. Therefore, the light emitted through portion atop the central axial line of the lamp cover is wasted.

### SUMMARY OF THE INVENTION

It is the object of the present invention to provide a traffic light with better efficiency and convenient maintenance.

In one aspect of the invention, the inventive traffic light uses light emitting diode with low thermal resistance as light source, the power consumption is reduced and the maintenance thereof is easy.

In another aspect of the invention, the inventive traffic light uses light emitting diode with low thermal resistance to replace LEDs of φ3 mm or φ5 mm as light source. The light emitting diode with low thermal resistance can provide illumination of 10 lumens. The number of LEDs used is reduced and the illumination is more uniform.

In another aspect of the invention, the LEDs are arranged on a copper plate aligned with 5-45° angle with respect to a base of a lampshade, whereby the light emitted from the LEDs is concentrated to portion below the central axial line of the lamp cover.

The various objects and advantages of the present invention will be more readily understood from the following detailed description when read in conjunction with the appended drawing, in which:

### BRIEF DESCRIPTION OF DRAWINGS

FIG. 1 is a sectional view showing a prior art traffic light;

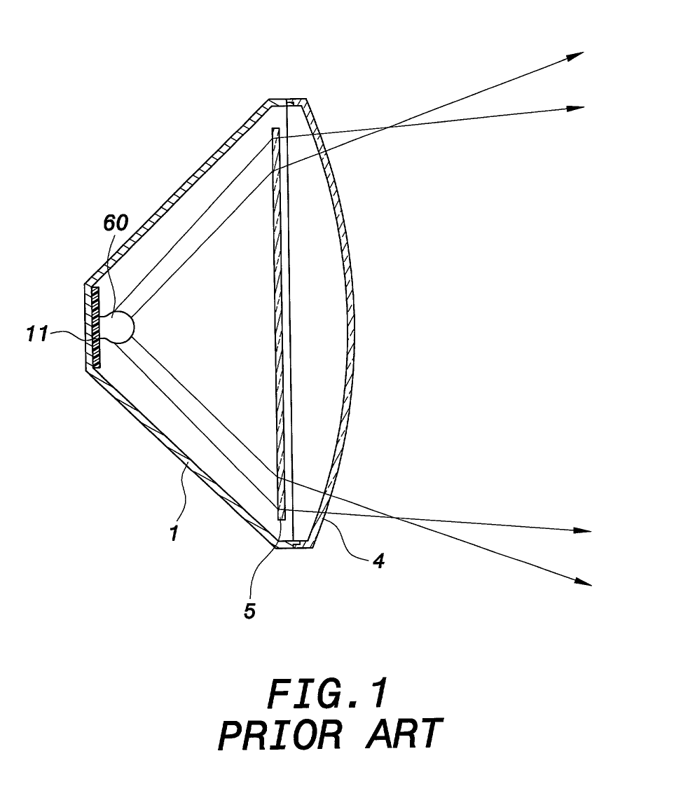

FIG. 2 is another sectional view showing a prior art traffic light;

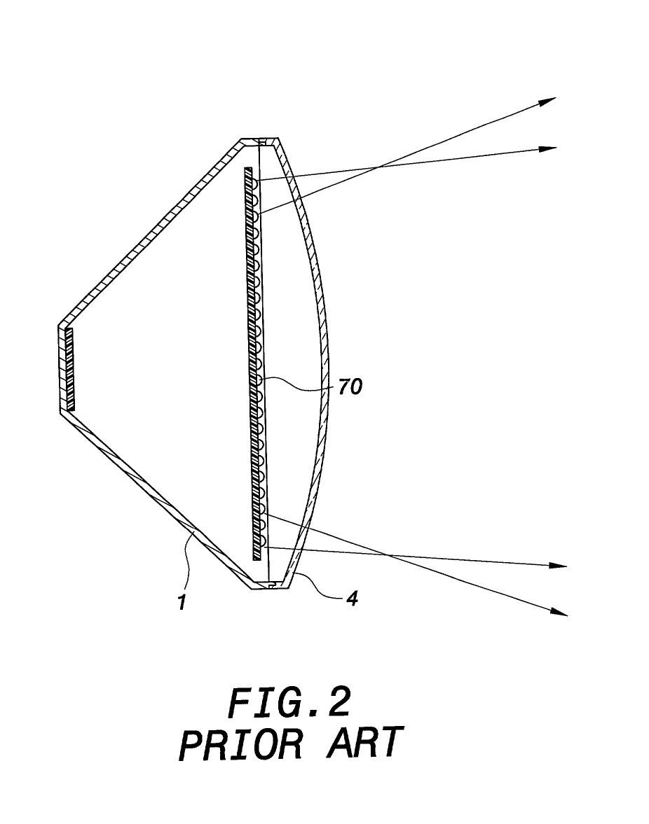

FIG. 3 is a sectional view of the traffic light of the present invention; and

FIG. 4 is a sectional view of the light emitting diode with low thermal resistance of the present invention.

### DETAILED DESCRIPTION OF THE INVENTION

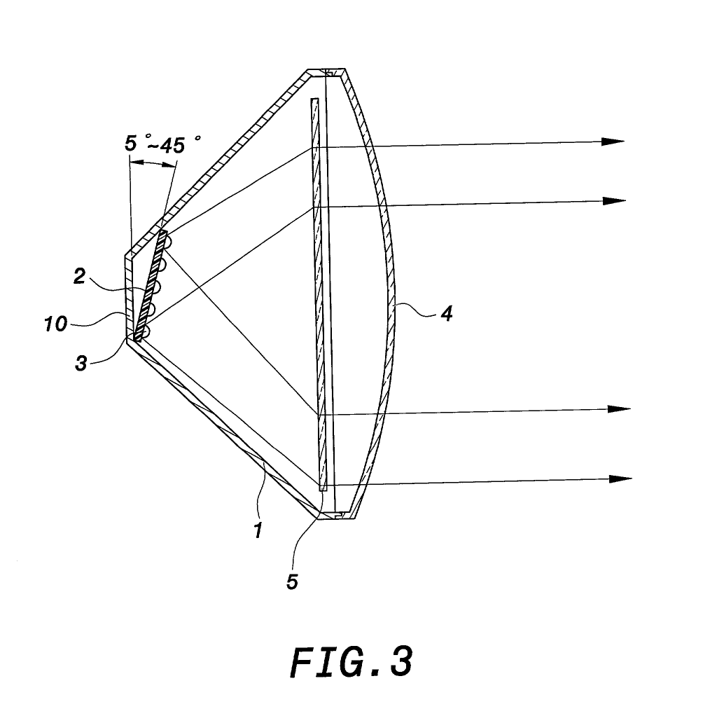

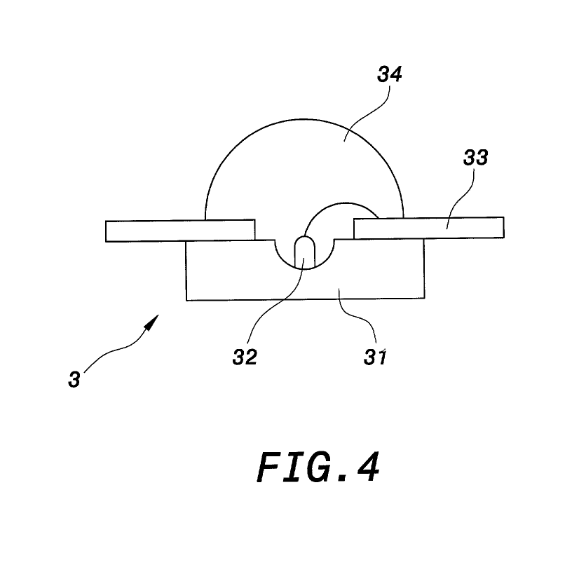

With reference now to FIGS. 3 and 4, the present invention provides a traffic light using light emitting diode with low thermal resistance as light source. The traffic light according to the present invention comprises a lampshade 1, a copper plate 2, a plurality of LEDs 3 with low thermal resistance, and a lamp cover 4.

The plurality of LEDs 3 are mounted on the copper base 2 and used as the light source of the traffic light. Each LED 3 has a die 32 mounted on a heat-dissipating plate 31. The die 32 has pads (not shown) wire bonded to a circuit board 33 and a protective encapsulation 34 is formed atop the die 32.

The copper plate 2 is placed on inner side of a base 10 of the lampshade 1 and aligned with 5-45° angle with respect to the base 11 of the lampshade 1, whereby the light emitted from the LEDs 3 is concentrated to portion below the central axial line of the lamp cover.

The lampshade 1 is made of metallic material such as Al or Cu, or metal material enclosed by plastic. The lampshade 1 has an opening and contains a light diffusion plate 5 therein and used to diffuse the light from the LEDs 3.

The lamp cover 4 is made of plastic material and arranged at the opening of the lampshade 1.

By above-mentioned arrangement, the number of the LEDs of φ3 mm or φ5 mm can be advantageously reduced while the brightness can be enhanced.

To sum up, the traffic light according to the present invention has following advantages:

(1). The use of LED with low thermal resistance as light source can save 80% electric power. Therefore, the number of the LEDs and the risk of LED malfunction can be reduced. For example, the prior art traffic light requires hundreds of LEDs of φ3 mm, while the inventive traffic light requires less than 18 LEDs of φ3 mm.

(2). The inventive traffic light has better brightness and is more suitable to traffic regulation.

(3). The light can be advantageously concentrated to more beneficial region.

(4). The security and power consumption are optimized with low maintenance requirement.

(5). The problem of non-uniform brightness due to malfunction of few LEDs can be solved.

Although the present invention has been described with reference to the preferred embodiment thereof, it will be understood that the invention is not limited to the details thereof. Various substitutions and modifications have suggested in the foregoing description, and other will occur to those of ordinary skill in the art. Therefore, all such substitutions and modifications are intended to be embraced within the scope of the invention as defined in the appended claims.

I claim:

1. A traffic light comprising
a lampshade having a base
a base plate placed on an inner side of the base and aligned with a predetermined angle with respect to the base; and
a plurality of LEDs mounted on the base plate and used as the light source of the traffic light.

2. The traffic light as in claim 1, wherein the lampshade has an opening and has a lamp cover arranged on the opening, the lampshade has a light diffusion plate therein and used to diffuse the light from the LEDs.

3. The traffic light as in claim 1, wherein the base plate is aligned with 5-45° angle with respect to the base of the lampshade.

4. The traffic light as in claim 1, wherein the base plate is a copper plate.

5. The traffic light as in claim 1, wherein each LED has a die mounted on a heat-dissipating plate, and has pads wire bonded to a circuit board and a protective encapsulation formed atop the die.
